(19) United States
(12) Patent Application Publication
(10) Pub. No.: US 2017/0166735 A1
(43) Pub. Date: Jun. 15, 2017

(54) PROCESS FOR PRODUCING STABLE AQUEOUS POLYMERIC DISPERSIONS AND COATINGS AND COATED GLASS ARTICLES USING THE SAME

(71) Applicant: Michelman, Inc., Cincinnati, OH (US)

(72) Inventors: Kenneth Scott Smallwood, Cincinnati, OH (US); Michael Kramer, Loveland, OH (US); Edward R. Gay, Cincinnati, OH (US)

(73) Assignee: Michelman, Inc., Cincinnati, OH (US)

(21) Appl. No.: 15/373,983

(22) Filed: Dec. 9, 2016

Related U.S. Application Data
(60) Provisional application No. 62/265,547, filed on Dec. 10, 2015.

(51) Int. Cl. C08L 23/08; C03C 17/30; C03C 17/00; C03C 17/32; C09D 123/08; G09F 3/02

(52) U.S. Cl. CPC C08L 23/0869; C09D 123/0869; G09F 3/02; C03C 17/005; C03C 17/328; C03C 17/32; C03C 17/30; C08L 2201/54; G09F 2003/023; G09F 2003/0273; C03C 2217/29; C03C 2217/78; C03C 2218/11; C03C 2218/32

(57) ABSTRACT

A process for producing an aqueous polymeric dispersion may include coextruding a copolymer of an α-olefin and an α,β-unsaturated carboxylic acid to form a combined polymer, and a wax. The process may include emulsifying the combined polymer and wax to form a dispersion, and adding an adhesion promoter to the dispersion. Also disclosed are coatings including the aqueous polymeric dispersion and coated glass articles having the aqueous polymeric dispersion coated thereon.

### CROSS-REFERENCE TO RELATED APPLICATIONS

This application claims priority to U.S. Provisional Patent Application Ser. No. 62/265,547, filed Dec. 10, 2015, and entitled “Process for Producing Stable Aqueous Polymeric Dispersions and Coatings and Coated Glass Articles Using the Same,” which is hereby incorporated by reference in its entirety.

### TECHNICAL FIELD

The present specification relates to processes for producing stable aqueous polymeric dispersions, and more particularly, to a process which produces a stable aqueous polymeric dispersion which may be applied as a coating to a variety of surfaces.

### BACKGROUND

Protective coatings based on polymers have been increasingly used in a number of applications because they provide a wide range of strength, flexibility, toughness, adhesion, abrasion resistance, chemical and/or moisture resistance, and other properties. For example, polymeric dispersions may be applied as protective coatings to a variety of surfaces including glass, metal, polymer, and cellulosic substrates.

When producing aqueous polymeric dispersions, it is important that the dispersion remain stable for a sufficient period of time to allow application to the intended substrate. By “stability,” it is meant the ability of a formulation to stay in a homogeneous state from the time it is mixed up until the time it is applied to the intended substrate surface. Because aqueous dispersions may be coated onto article surfaces during manufacturing processes, it is critical that the dispersions remain stable in order to avoid a loss of the desired properties and/or a loss of efficiency during the manufacturing process.

Accordingly, the need exists for a process for preparing a stable aqueous polymeric dispersion which can be applied to a variety of substrate surfaces and which provides properties such as abrasion resistance, transparency, adherence, and chemical and/or moisture resistance.

### SUMMARY

In accordance with one embodiment of the present disclosure, a process for producing a stable aqueous polymeric dispersion is provided which includes providing (a) a copolymer of an α-olefin and an α,β-unsaturated carboxylic acid, and (b) a wax. The copolymer and wax may be combined and then emulsified to form the dispersion. The process may include adding an adhesion promoter to the dispersion.

Embodiments of the present disclosure additionally provide for a stable aqueous polymeric dispersion. The stable aqueous polymeric dispersion includes an aqueous dispersion of a combined polymer. The combined polymer includes a wax and a copolymer of an α-olefin and an α,β-unsaturated carboxylic acid.

Additional features and advantages will be set forth in the detailed description which follows, and in part will be readily apparent to those skilled in the art from that description or recognized by practicing the embodiments described herein, including the detailed description which follows and the claims.

It is to be understood that both the foregoing general description and the following detailed description describe various embodiments and are intended to provide an overview or framework for understanding the nature and character of the claimed subject matter.

### DETAILED DESCRIPTION

Reference will now be made in detail to various embodiments of stable aqueous polymeric dispersions. In general, various embodiments provide an aqueous dispersion of a combined polymer including a wax and a copolymer of an α-olefin and an α,β-unsaturated carboxylic acid and processes for making the aqueous dispersion. The aqueous dispersion is stable and may be employed as a protective coating for a number of substrates including glass articles such as containers or glass fibers, metal substrates, polymeric substrates, and cellulosic substrates. In addition, the coating may provide abrasion resistance, good adhesion, and resistance to degradation from moisture and/or chemicals. In embodiments, the dispersion remains stable upon formation for at least 30 days.

Unless otherwise indicated, the disclosure of any ranges in the specification and claims are to be understood as including the range itself and also anything subsumed therein, as well as endpoints.

Embodiments of the present disclosure are directed to aqueous dispersions including wax, and a copolymer. As used herein, “copolymer” refers to a polymer made up of two or more monomers. Some embodiments further include an adhesion promoter. Various compositions and amounts are contemplated for the wax and copolymer. In various embodiments, the dispersion may include a combined polymer comprising from about 1 wt % to about 40 wt % based on the weight of the combined polymer of a copolymer of an α-olefin and an α,β-unsaturated carboxylic acid, from about 41 wt % to about 99 wt % based on the weight of the combined polymer of a wax. In other embodiments, the combined polymer may include from about 10 wt % to about 40 wt % based on the weight of the combined polymer of the copolymer of the α-olefin and the α,β-unsaturated carboxylic acid, from about 20 wt % to about 39 wt % based on the weight of the combined polymer of the copolymer of the α-olefin and the α,β-unsaturated carboxylic acid, or from about 30 wt % to about 38 wt % based on the weight of the combined polymer of the copolymer of the α-olefin and the α,β-unsaturated carboxylic acid. The combined polymer may include from about 45 wt % to about 95 wt % based on the weight of the combined polymer of the wax, from about 50 wt % to about 80 wt % based on the weight of the combined polymer of the wax, or from about 60 wt % to about 70 wt % based on the weight of the combined polymer of the wax. In one specific embodiment, the combined polymer includes about 35 wt % based on the weight of the combined polymer of the copolymer of the α-olefin and the α,β-unsaturated carboxylic acid and about 65 wt % based on the weight of the combined polymer of the wax. In still other embodiments, the combined polymer may be from about 1 wt % to about 99 wt % based on the weight of the combined polymer of the copolymer of the α-olefin and the α,β-unsaturated carboxylic acid and from about 1 wt % to about 99 wt % based on the weight of the combined polymer of the wax. The combined polymer may be, for example, a compounded polymer.

The copolymer of the α-olefin and the α,β-unsaturated carboxylic acid may include from about 60 wt % to about 95 wt % of the α-olefin, from about 70 wt % to about 90 wt % of the α-olefin, or from about 78 wt % to about 85 wt % of the α-olefin and from about 5 wt % to about 40 wt % of the α,β-unsaturated carboxylic acid, from about 10 wt % to about 30 wt % of the α,β-unsaturated carboxylic acid, or from about 15 wt % to about 22 wt % of the α,β-unsaturated carboxylic acid. The α-olefin may be, by way of example and not limitation, ethylene, propylene, isobutylene, 1-butene, 1-pentene, 1-hexene, 4-methyl-1-pentene, 1-octene, or combinations thereof. The α,β-unsaturated carboxylic acid may be, by way of example and not limitation, methacrylic acid, acrylic acid, maleic acid, fumaric acid, sorbic acid, or combinations thereof. In some embodiments, the copolymer includes ethylene and at least one of acrylic acid or methacrylic acid. In other embodiments, the copolymer is an ionomer, such as an ionomer of ethylene and methacrylic acid or an ionomer of ethylene and acrylic acid. Suitable copolymers of ethylene and methacrylic acid include Surlyn®, commercially available from DuPont.

Various embodiments of the aqueous dispersion include a copolymer that has a melt flow rate of from about 3 g/10 minutes to about 5.5 g/10 minutes at 190° C. and 2.16 kg as measured according to ASTM D1238. In some embodiments, the copolymer has a melt flow rate of from about 3.5 g/10 minutes to about 5.0 g/10 minutes at 190° C. and 2.16 kg. One particular embodiment includes a copolymer having a melt flow rate of 4.5 g/10 minutes at 190° C. and 2.16 kg. The copolymer may have a Shore D hardness of from about 30 to about 100, from about 40 to about 90, from about 50 to about 80, or even from about 60 to about 70, when measured according to ASTM 2240.

In various embodiments, the copolymer may be selected based at least in part on its flexural modulus. The flexural modulus, sometimes referred to as the “bending modulus,” is a quantification of the tendency of a material to bend. In particular, the flexural modulus is the ratio of stress to strain in flexural deformation. The flexural modulus is determined from the slope of a stress-strain curve produced by a flexural test. In various embodiments, the copolymer has a flexural modulus of greater than about 27 MPa at 23° C., as measured according to ASTM D790, procedure B. For example, the copolymer may have a flexural modulus of from about 27 MPa to about 620 MPa, or from about 29 MPa to about 520 MPa. In one particular embodiment, the copolymer has a flexural modulus of from about 450 MPa to about 500 MPa.

Alternatively or in addition, the copolymer may be selected based at least in part on its tensile strength. In various embodiments, the copolymer has a tensile strength of greater than about 10 MPa or greater than about 13 MPa at 23° C., as measured according to ASTM D638. For example, the copolymer may have a tensile strength of from about 10 MPa to about 40 MPa, or from about 12 MPa to about 39 MPa, or from about 15 MPa to about 38 MPa. In one particular embodiment, the copolymer has a tensile strength of from about 25 MPa to about 35 MPa.

Suitable waxes for use in the coating may include natural and synthetic waxes. For example, animal waxes, such as beeswax, Chinese wax, shellac wax, spermaceti and wool wax (lanolin); vegetable waxes, such as bayberry wax, candelilla wax, carnauba wax, castor wax, esparto wax, Japan wax, Jojoba oil wax, ouricury wax, rice bran wax and soy wax; mineral waxes, such as ceresin waxes, montan wax, ozocerite wax and peat waxes; petroleum waxes, such as paraffin wax and microcrystalline waxes; and synthetic waxes, including polyolefin waxes, including polyethylene and polypropylene waxes, wax grade polytetrafluoroethylene waxes (PTFE wax-like grades), Fischer-Tropsch waxes, stearamide waxes (including ethylene bis-stearamide waxes), polymerized α-olefin waxes, substituted amide waxes (e.g., esterified or saponified substituted amide waxes), and combinations thereof. In particular embodiments, the coating includes polyethylene wax, which may be non-functionalized or functionalized, maleated polypropylene wax, or a polyamide wax. In particular embodiments, the polyethylene wax is an oxidized high density polyethylene (HDPE). A suitable HDPE is AC®-316 commercially available from Honeywell, which is a high density oxidized polyethylene wax. Other HDPE wax materials may be used including those available commercially available from Honeywell under the designation 316 and the OPI 1300 series of oxidized high density polyethylene waxes commercially available from Oxidized Polyethylene Industries, Inc.

In some embodiments, the aqueous dispersion may include waxes that have a viscosity suitable to lower the melt flow rate of the copolymer when combined with the copolymer without negating the hardness properties of the copolymer. The viscosity of the wax may be, for example, from about 5,000 cps to about 10,000 cps at 150° C., from about 6,000 cps to about 9,000 cps at 150° C., or from about 8,000 cps to about 9,000 cps at 150° C. In one particular embodiment, a high density polyethylene wax having a viscosity of about 8500 cps at 150° C. may be added to the copolymer, resulting in a combined copolymer suitable for dispersion while retaining the hardness of the copolymer.

Various methodologies are contemplated for combining the wax and copolymer. In one embodiment, the copolymer and wax may be co-extruded by a heated extrusion process to form a compounded polymer. For example, a twin-screw extruder may be employed to co-extrude the copolymer and wax. As described hereinabove, the copolymer and wax may be co-extruded to form a copolymer including from about 1 wt % to about 40 wt % copolymer and 41 wt % to about 99 wt % wax, from about 10 wt % to about 40 wt % copolymer and from about 45 wt % to about 95 wt % wax, from about 20 wt % to about 39 wt % copolymer and from about 50 wt % to about 80 wt % wax, or from about 30 wt % to about 38 wt % copolymer and from about 60 wt % to about 70 wt % wax. In one particular embodiment, about 35 wt % copolymer was co-extruded with about 65 wt % wax.

Other suitable methods may be employed to form the combined polymer. By way of example and not limitation, the copolymer and wax may be blended together in a pressurized blending vessel to form the combined polymer. The blending vessel may be, for example, a glass or metal vessel capable of withstanding pressures of at least about 100 psi.

After extrusion, the combined polymer may be emulsified in an aqueous solution. A nonionic or anionic emulsifier (i.e., surfactant) or dispersing agent may be used for emulsification. Suitable emulsifiers include, by way of example and not limitation, ammonia, potassium hydroxide, sodium hydroxide, dimethylethanolamine (DMEA), ammonium hydroxide, ethoylated alcohols, stearyl alcohols, nonoxynols, sorbitan monostearate, polyethylene glycol octadecyl ether, polyoxyethylene (20) stearyl ether, potassium lauryl sulfate, ammonium lauryl sulfate, sodium stearate, and combinations thereof. From about 2 wt % to about 12 wt % of emulsifier, from about 3 wt % to about 10 wt % of emulsifier, or from about 5 wt % to about 7 wt % of emulsifier based on weight of the aqueous solution may be employed. In various embodiments, the emulsification has a total solids content of from about 10 wt % to about 30 wt %, from about 15 wt % to about 25 wt %, or from about 18 wt % to about 22 wt %. One particular embodiment results in an emulsification having a total solids content of about 21%.

The emulsion may then be diluted with water. The diluted emulsification may have a total solids content of from about 0.01 wt % to about 15 wt %, from about 0.05 wt % to about 12 wt %, or from about 0.1 wt % to about 10 wt %.

The dispersion may also include an adhesion promoter. The adhesion promoter may be included in an amount of from about 0.01 wt % to about 15 wt % based on a weight of the dispersion, from about 0.1 wt % to about 10 wt % based on a weight of the dispersion, or from about 1 wt % to about 5 wt % based on a weight of the dispersion. In various embodiments, the adhesion promoter may be an acrylic polymer, an epoxy, a silane, a resin, a rosin, or a combination thereof. In some embodiments, the adhesion promoter is a silane adhesion promoter modified with organic reactive functional groups. Suitable organic reactive functional groups include, by way of example and not limitation, amine reactive groups. Accordingly, adhesion promoters for use in various embodiments include aminosilanes such as 3-aminopropyltriethoxysilane or 3-aminopropyltrimethoxysilane, 3-aminopropyltriethoxysilane, 4-aminobutyltrimethoxysilane, N-methyl-3-aminopropyltrimethoxysilane, or 3-aminopropyltris(2-methoxyethoxyethoxy)silane. Without being bound by theory, the adhesion promoter may aid in promoting adhesion of the dispersion to a substrate, such as glass, metal, polymers, cellulose, or combinations thereof. When a silane adhesion promoter is employed, the silane may be dispersed in water and mixed for a sufficient time to hydrolyze (e.g., at least about 5 minutes) prior to being added to the diluted aqueous emulsion.

After emulsification and dilution, the dispersion may include from about 0.075 wt % to about 0.75 wt % based on the weight of the dispersion of the combined polymer and from about 0.01 wt % to about 15 wt % based on weight of the dispersion of the adhesion promoter.

The dispersion may contain particles having a size of from about 0.01 μm to about 1.0 μm, from about 0.01 μm to about 0.5 μm, or even from about 0.01 μm to 0.10 μm, depending on the particular embodiment. In various embodiments, particle size is limited to reduce or eliminate undesirable characteristics in the dispersion. For example, particles larger than 1.0 μm may result in a cloudy dispersion or coating when the dispersion is applied to a glass article.

The dispersion may be applied in the form of a coating to a substrate surface, such as by spray atomization, vaporization, spraying, or brushing using equipment which is conventional in the art. The coating may be applied in an in-line manufacturing process. For example, the coating may be applied during manufacture of glass articles such as hollow containers or during manufacture of glass fibers. Once coated onto a substrate surface, the coating may form a transparent protective film.

The coating may be deposited on a glass article having an initial temperature of from about 75° C. to about 125° C. or from about 105° C. to about 125° C. by spraying or brushing using equipment which is conventional in the art. The coating may be applied as a diluted spray or neat. In some embodiments, the coating may be applied at the exit of the annealing lehr during manufacture of the glass article. In various embodiments, the coating is applied to the glass article at a temperature of from about 80° C. to about 100° C.

After the coating has been applied to the glass article, the coated glass article is then heated to a temperature above the initial temperature of the glass article. For example, the coated glass article may be heated to a temperature of greater than about 60° C., a temperature of greater than about 120° C., a temperature of from about 120° C. to about 150° C., or from about 130° C. to about 140° C. The coated glass article may be heated from about 15 seconds to about 45 seconds, depending on the line speed. An infrared heat source, a conduction heat source, a convection heat source, an advection heat source, a heated vapor deposition apparatus, or any other type of external heat source may be employed in various embodiments to heat the coated glass article. In some embodiments, multiple types of heating may be combined. For example, convection heating may be used with an infrared heat source, a conduction heat source, an advection heat source, a heated vapor deposition apparatus, or any other type of external heat source. Heat sources may be gas or electric powered, depending on the particular embodiment. Without being bound by theory, heating the coated glass article drives off water in the coating, enables silane bonding, and enables the copolymer and wax to form a film. Following heating, the coated glass article is allowed to cool to ambient temperature.

Various embodiments described hereinabove result in a coating that meets or exceeds industry standards and/or provides application results desired for the particular embodiment. For example, in various embodiments, the coating provides a scratch resistance of greater than about 30 pounds, greater than about 45 pounds, greater than about 60 pounds, greater than about 75 pounds, or even greater than about 90 pounds in wet and/or dry conditions.

In various embodiments, articles coated with the coating have an internal pressure strength (or burst pressure) of greater than about 210 psi, greater than about 250 psi, greater than about 300 psi, greater than about 325 psi, greater than about 400 psi, or even greater than about 500 psi when measured in accordance with ASTM C-147, method B. For example, articles coated with the coating may have an internal pressure strength of from about 210 psi to about 725 psi, from about 250 psi to about 720 psi, from about 350 psi to about 710 psi, from about 375 psi to about 600 psi, or even from about 400 psi to about 570 psi when measured in accordance with ASTM C-147, method B. In still other embodiments, articles coated with the coating may have an internal pressure strength of from about 400 psi to about 710 psi before being passed through a manufacturing line and/or an internal pressure strength of from about 350 psi to about 600 psi after being passed through a manufacturing line.

In various embodiments, the coating provides label retention of greater than or equal to about 50%, greater than or equal to about 60%, greater than or equal to about 70%, greater than or equal to about 75%, greater than or equal to about 80%, greater than or equal to about 90%, or even greater than or equal to about 95% after a 24 hour cure period.

### EXAMPLES

The following examples are provided to illustrate various embodiments, but are not intended to limit the scope of the claims. All parts and percentages are by weight unless otherwise indicated.

### Example 1

### Scratch Testing

Flint 750 mL wine bottles were manufactured according to conventional glass bottle manufacturing methods, including molding, annealing, and cooling. Comparative Sample 1 was additionally coated using a traditional hot end coating process followed by a cold end coating process. The hot end coating was applied via chemical vapor deposition before the bottle entered the annealing lehr. The hot end coating was neat monobutyltin-oxide. Then, a cold end coating including polyethylene wax dispersed in water at a dilution rate of 100:1 coating was applied after the bottle left the annealing lehr. Following application of the polyethylene wax coating, the bottles were cooled in accordance with typical manufacturing methods.

To prepare Sample 1, a bottle emerging from the annealing lehr was treated with a cold end coating composition. The cold end coating composition was made by co-extruding by a heated extrusion process 65 wt % AC®-316 (an oxidized high density polyethylene (HDPE) wax commercially available from Honeywell) with 35 wt % Surlyn® (a copolymer of ethylene and methacrylic acid commercially available from DuPont). After extrusion, the combined polymer was emulsified to form a 21% solids emulsification. An aminosilane was added to the emulsification, and the emulsification was diluted with water to produce the coating composition. Coating composition included 0.5 wt % aminosilane, 1.5% polymer, and 98% water.

The coating composition was applied via spray to the bottle at an initial temperature of from about 80° C. to about 100° C. After being coated, the bottle was heated to a temperature of from about 115° C. to about 120° C. using an electric convection heating system including variable temperature heaters and blowers for 90 seconds to cure the coating composition. Following curing, Sample 1 was cooled in the same way as Comparative Sample 1.

Scratch testing was performed on Sample 1 and Comparative Sample 1. During the scratch testing, the sidewall regions of two bottles from Sample 1 and Comparative Sample 1 were slid together under increasing normally applied loads. The scratch resistance was defined as the maximum load the bottles could endure without the creation of frictive damage during sliding contact. Bottles were tested under wet sliding conditions, with the contact area flooded with deionized water. The scratch test data is provided in Table 1 below.

TABLE 1
Wet Scratch Test Results

| | 15 lb | 30 lb | 45 lb | 60 lb | 75 lb | 90 lb |
|---|---|---|---|---|---|---|
| Sample 1 | Pass | Pass | Pass | Pass | Pass | Pass |
| Comparative | Pass | Pass | Pass | Fail | | |
| Sample 1 | | | | | | |

As indicated in Table 1, Sample 1 passed a load of 90 lb under wet conditions. However, Comparative Sample 1 passed a load of 45 lb, but failed to pass a load of 60 lb. Accordingly, Sample 1 showed improvement over bottles coated according to conventional methods. Notably, Sample 1 demonstrated that a cold-end coating, without the use of a hot-end coating, could provide comparable or even improved wet scratch resistance to the hot and cold-end coating combination used in Comparative Sample 1.

Dry scratch testing was performed on Sample 1 and Comparative Sample 1. During the scratch testing, the sidewall regions of two dry bottles from Sample 1 and Comparative Sample 1 were slid together under increasing normally applied loads under dry sliding conditions. The scratch resistance was defined as the maximum load the bottles could endure without the creation of frictive damage during sliding contact. The scratch test data is provided in Table 2 below.

TABLE 2
Dry Scratch Test Results

| | 15 lb | 30 lb | 45 lb | 60 lb | 75 lb | 90 lb |
|---|---|---|---|---|---|---|
| Sample 1 | Pass | Pass | Fail | | | |
| Comparative | Pass | Fail | | | | |
| Sample 1 | | | | | | |

As indicated in Table 2, Sample 1 passed a load of 30 lb but failed to pass a load of 45 lb under dry conditions (i.e., frictive damage was created at a load level less than 45 lb). In contrast, Comparative Sample 1 failed to pass a load of 30 lb. Accordingly, Sample 1 showed improvement over bottles coated according to conventional methods. Notably, Sample 1 demonstrated that a cold-end coating, without the use of a hot-end coating, could provide comparable or even improved scratch resistance to the hot and cold-end coating combination of Comparative Sample 1.

### Example 2

### Internal Pressure Resistance

Samples 2-49 were prepared by coating amber 330 mL beer bottles with the Sample 1 coating described above in Example 1. As in Example 1, the bottles were coated after the bottles emerged from the annealing lehr. For Samples 2-25, internal pressure resistance was measured with an AGR Ramp 2 Pressure Tester (American Glass Research, Butler, Pa.) in accordance with ASTM C-147, method B. Internal pressure resistance is a measure of the internal pressure strength of the bottles. The internal pressure resistance of each of the samples is provided in Table 3 below.

TABLE 3
Internal Pressure Resistance

| | Pressure | |
|---|---|---|
| Sample | (psi) | Origin Location |
| 2 | 563 | Bearing surface |
| 3 | 521 | Upper sidewall |
| 4 | 530 | Bearing surface |
| 5 | 565 | Lower sidewall |
| 6 | 551 | Heel contact |
| 7 | 472 | Shoulder contact |
| 8 | 528 | Bearing surface |
| 9 | 524 | Bearing surface |
| 10 | 443 | Heel contact |
| 11 | 513 | Bearing surface |
| 12 | 701 | Bearing surface |
| 13 | 517 | Heel contact |
| 14 | 472 | Shoulder contact |
| 15 | 570 | Heel contact |
| 16 | 678 | Mid sidewall |
| 17 | 540 | Shoulder contact |
| 18 | 407 | Bearing surface |
| 19 | 506 | Heel contact |
| 20 | 479 | Bearing surface |
| 21 | 651 | Shoulder contact |
| 22 | 495 | Mid sidewall |
| 23 | 566 | Heel contact |
| 24 | 511 | Heel contact |
| 25 | 553 | Heel contact |

The internal pressure strength for each of Samples 2-25 was between 407 and 701 psi, with an average internal pressure strength across the samples of 535.6 psi.

The bottles of Samples 26-49 were subjected to a one-minute wet line simulation using AGR's Line Simulator to simulate handling damage on the bottles comparable to that produced on the ware following a trip through a typical filling line. Following the line simulation, the internal pressure resistance was measured with an AGR Ramp 2 Pressure Tester (American Glass Research, Butler, Pa.) in accordance with ASTM C-147, method B. The internal pressure resistance of each of the samples is provided in Table 4 below.

TABLE 4
Internal Pressure Resistance

| | Pressure | |
|---|---|---|
| Sample | (psi) | Origin Location |
| 26 | 463 | Upper sidewall |
| 27 | 389 | Shoulder contact |
| 28 | 478 | Bearing surface |
| 29 | 452 | Shoulder contact |
| 30 | 441 | Bearing surface |
| 31 | 479 | Heel contact |
| 32 | 433 | Shoulder contact |
| 33 | 384 | Shoulder contact |
| 34 | 536 | Mid sidewall |
| 35 | 570 | Bearing surface |
| 36 | 384 | Lower sidewall |
| 37 | 473 | Lower sidewall |
| 38 | 566 | Heel contact |
| 39 | 499 | Bearing surface |
| 40 | 498 | Shoulder contact |
| 41 | 471 | Bearing surface |
| 42 | 411 | Heel contact |
| 43 | 558 | Shoulder contact |
| 44 | 521 | Heel contact |
| 45 | 403 | Bearing surface |
| 46 | 580 | Upper sidewall |
| 47 | 559 | Lower sidewall |
| 48 | 437 | Mid sidewall |
| 49 | 421 | Lower sidewall |

The internal pressure resistance for each of Samples 26-49 was between 384 and 580 psi, with an average internal pressure resistance across the samples of 475.25 psi. As expected, the internal pressure resistance of the Samples decreased after exposure to the line simulation treatment as compared to the internal pressure resistance observed for Samples 2-25.

Moreover, an overall comparison showed some shifting of the origin location after line simulation treatment. In particular, fewer failures originated at the bearing surface after line simulation, while more failures originated at the sidewall following line simulation treatment.

As shown in Tables 3 and 4, the coated articles exhibit internal pressure strengths of greater than 210 psi, which is the current industry standard. Moreover, each of Samples 2-49 exhibited an internal pressure strength of greater than 375 psi, even after a line simulation treatment, with Samples 2-25 each exhibiting an internal pressure strength of greater than 400 psi.

### Example 3

### Label Adhesion

Samples 50 and 51 were prepared by coating amber 330 mL beer bottles with the Sample 1 coating as described above in Example 2. For Sample 50, the label was applied using Colfix 6009 glue (a casein-based glue available from KIC Krones Internationale Cooperationsgesellschaft mbH (Germany)). S 4021 glue (an acrylic-based glue available from KIC Krones Internationale Cooperationsgesellschaft mbH (Germany)) was used to apply the label to Sample 51. Glue was applied to the back of the labels via smooth metal rod and then manually applied to the surface of each bottle. After a 24 hour cure period at room temperature, label adhesion was tested by peeling off the label and evaluating the fiber tear. The results, reported as the percentage of label remaining on the bottle after tearing, are presented in Table 5 below.

TABLE 5
Label Adhesion Testing Results

| | | % Label |
|---|---|---|
| Sample | Glue | Remaining |
| 50 | Colfix 6009 | 95 |
| 51 | S 4021 | 80 |

As shown in Table 5, Sample 50, which had a label applied with Colfix 6009 glue, exhibited 95% retention after the 24 hour cure period. For Sample 51, which had a label applied with S 4021 glue, the retention ranged was 80%. The greater the amount of label remaining on the bottle, the stronger the adhesion. According to some industry standards, a desired label retention is greater than or equal to about 50% of the label. Thus, Samples 50 and 51 exhibited adhesion that surpasses the acceptable industry standard.

As described hereinabove, a single coating including the copolymer and the adhesion promoter is applied to the glass article, which may eliminate the need for additional coatings or processing steps. In various embodiments, the coating may be deposited directly on a surface of the glass article. For example, the coating is disposed on the surface of the glass article without a hot end coating, a coating including tin oxide, or another intervening layer disposed between the coating and the glass article. Accordingly, without being bound by theory, various embodiments may provide a cold end coating that may reduce potential environmental concerns associated with typical hot end coatings, provide efficiency improvements by eliminating a step in the process, and allow quality processing equipment to be installed on the lines where the current hot end coatings are applied.

It is noted that terms like “preferably,” “commonly,” and “typically” are not utilized herein to limit the scope of the claimed embodiments or to imply that certain features are critical, essential, or even important to the structure or function of the claimed embodiments. Rather, these terms are merely intended to highlight alternative or additional features that may or may not be utilized in a particular embodiment of the present disclosure.

Having described the embodiments in detail, it will be apparent that modifications and variations are possible without departing from the scope of the present disclosure defined in the appended claims. More specifically, although some aspects of the present disclosure are identified herein as preferred or particularly advantageous, it is contemplated that the present disclosure is not necessarily limited to these preferred aspects of the disclosure.

What is claimed is:

1. A process for producing an aqueous polymeric dispersion comprising:
emulsifying a combined polymer to form the aqueous polymeric dispersion, wherein the combined polymer comprises (a) a copolymer of an α-olefin and an α,β-unsaturated carboxylic acid, and (b) a wax.

2. The process of claim 1, wherein the compounded polymer comprises from about 1 wt % to about 40 wt % based on the weight of the compounded polymer of the copolymer and from about 41 wt % to about 99 wt % based on the weight of the compounded polymer of the wax.

3. The process of claim 1, wherein the copolymer comprises a copolymer of ethylene and at least one of methacrylic acid or acrylic acid.

4. The process of claim 1, further comprising:
providing (a) the copolymer of the α-olefin and the α,β-unsaturated carboxylic acid, and (b) the wax;
co-extruding the copolymer and the wax to form a compounded polymer; and

5. The process of claim 4, further comprising:
adding an adhesion promoter to the aqueous dispersion.

6. The process of claim 5, further comprising:
applying the dispersion to a substrate selected from glass, metal, polymers, and cellulose after adding the adhesion promoter to the dispersion.

7. The process of claim 5, wherein the adhesion promoter is hydrolyzed prior to being added to the dispersion.

8. The process of claim 5, wherein the adhesion promoter comprises a silane adhesion promoter modified with an organic reactive functional group.

9. The process of claim 8, wherein the adhesion promoter comprises an aminosilane.

10. An aqueous polymeric dispersion comprising:
an aqueous dispersion of a combined polymer comprising a wax and a copolymer of an α-olefin and an α,β-unsaturated carboxylic acid.

11. The aqueous polymeric dispersion of claim 10, further comprising an adhesion promoter comprising 3-aminopropyltriethoxysilane.

12. The aqueous dispersion of claim 10, wherein the wax comprises an animal wax, a vegetable wax, a mineral wax, a petroleum wax, a synthetic wax, or a combination thereof.

13. The aqueous polymeric dispersion of claim 10, wherein the copolymer comprises a copolymer of ethylene and at least one of methacrylic acid or acrylic acid.

14. The aqueous dispersion of claim 13, wherein the copolymer has a tensile strength of from about 10 MPa to about 40 MPa at 23° C., as measured according to ASTM D638.

15. The aqueous dispersion of claim 13, wherein the copolymer has a flexural modulus of greater than about 27 MPa at 23° C., as measured according to ASTM D790, procedure B.

16. A coated substrate comprising a substrate and the aqueous polymeric dispersion of claim 13 coated thereon.

17. A coating for application to a glass article comprising:
a combined polymer comprising:
(a) a copolymer of an α-olefin and an α,β-unsaturated carboxylic acid; and
(b) a wax; and
an adhesion promoter.

18. The coating of claim 17, wherein the adhesion promoter comprises a silane adhesion promoter modified with an organic reactive functional group.

19. The coating of claim 17, wherein the wax comprises an oxidized high density polyethylene.

20. The coating of claim 17, wherein the coating has a scratch resistance of at least 60 pounds after adhesion to the glass article.
